(19) United States
(12) Patent Application Publication
(10) Pub. No.: US 2007/0273841 A1
(43) Pub. Date: Nov. 29, 2007

(54) Projection system and color wheel thereof

(75) Inventors: Ching-Hsiang Yu, Taoyuan Hsien (TW); Chia-Chi Wu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/703,680

(22) Filed: Feb. 8, 2007

(30) Foreign Application Priority Data
May 26, 2006 (TW) 95118734

(51) Int. Cl. G03B 21/14

(52) U.S. Cl. 353/84

(57) ABSTRACT

A projection system for forming an image, comprising a light source generating light beam; a color wheel used for performing color separation on the light beam of the light source, comprising a motor having a shaft, a carrier pivoted to the shaft of the motor, and a plurality of color filters fixedly disposed at the periphery of the carrier to form at least one gap; and a digital micromirror element used for reflecting the performed filtered light beams of the light source from the color wheel to form the image.

### BACKGROUND OF THE INVENTION

1. Field of the Invention

The invention relates to a projection system, and in particular, to a color wheel for a projection system to improve brightness of projected images.

2. Description of the Related Art

In projection systems such as projectors and projection televisions provided with the DLP system of Texas Instruments Inc., a light beam from a light source is split into three colors of red, green and blue by a color wheel. The red, green and blue light beams are reflected by a Digital Micromirror Device (DMD) and projected as an image on a screen to present color projecting images.

A transparent filter, except the three color (red, green and blue) filters, can be utilized to provide a four-color filter, thus, white light can be generated from the light source.

In FIG. 1A, a conventional color wheel 10 includes a carrier 4 and four-color filters “R”, “G”, “B” and “W” which are represented the red, green, blue and transparent, respectively, disposed on the carrier 4. In FIG. 1B, a side view of the color wheel 10 is presented. Another conventional color wheel, the so-called “8-section color wheel device” (not shown in Figs.) includes two sets of four sections, i.e., red, green, blue and transparent color filters. It is understood that the white filter in any color wheel is configured to improve brightness of projected images in different projection systems based on the controlling signal of the DMD, or to synchronically lock the pulse signals under the transparent section to decrease image flickering.

By cutting a glass plate coated with anti-reflective films of different colors into pieces according to the desired or sectional shape, these pieces disposed at the periphery of the carrier 4 can form the color wheel. Light beam passing through the color filters can be split into groups. However, the light transmission rate of the light beam passing through the transparent filter decays and is less than 100%.

### BRIEF SUMMARY OF THE INVENTION

The invention provides a color wheel for improving brightness of images projected by a projection system. The color wheel of the projection system of the invention includes a carrier and a plurality of color filters fixedly disposed at the periphery of the carrier to form at least one gap. When the color wheel is rotated, the light beam can pass completely through the gap, thus the conventional transparent filter can be eliminated so that a decrease in the light transmission rate can be prevented. The color wheel further includes a balancer disposed at the gap of the carrier. The balancer forms a moment couple with respect to the red, green and blue color filters to balance the weight thereof, to keep the center of mass of the color wheel maintained at the geometric rotation center of the color wheel, and to avoid vibration and noise from the high-speed rotational color wheel.

The color wheel of the invention can be formed with two gaps of the same size arranged symmetrically with respect to the carrier. Furthermore, the color wheel of the invention can be formed with three identical gaps formed with same size and symmetrically arranged. Each gap has a central line and an angle of 120 degrees is formed between the central lines of the gaps with respect to a center of the carrier, thus to form a moment couple on the color wheel to balance the rotational color wheel.

The color wheel further includes a fixing ring disposed along edges of the color filters and extends to one side thereof to form a moment couple on the color wheel to balance the rotational color wheel and to reduce the rotational wind-cutting noise.

Note that the color wheel of the invention can be applied to a conventional projection system to improve brightness of projecting images without changing any elements or basic configuration.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a front view of a conventional color wheel;

FIG. 1B is a side view of the color wheel of FIG. 1A;

FIG. 2 is a front view of a color wheel of a first embodiment of the invention;

FIG. 3 is a front view of a color wheel of a second embodiment of the invention;

FIG. 4 is a front view of a color wheel of a third embodiment of the invention;

FIG. 5A is a front view of a color wheel of a fourth embodiment of the invention;

FIG. 5B is a side view of the color wheel of FIG. 5A; and

FIG. 5C is a partially enlarged view of zone (z) of FIG. 5B;

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a projection system for forming an image. The projection system includes a light source generating a light beam, a color wheel used for performing color separation on the light beam of the light source, and a digital micromirror element used for reflecting the filtered light beam of the light source from the color wheel to form the image. The color wheel includes a motor having a shaft (not shown) and color filters disposed around the motor. The following description is of four color wheels 20, 30, 40 and 30A of the invention.

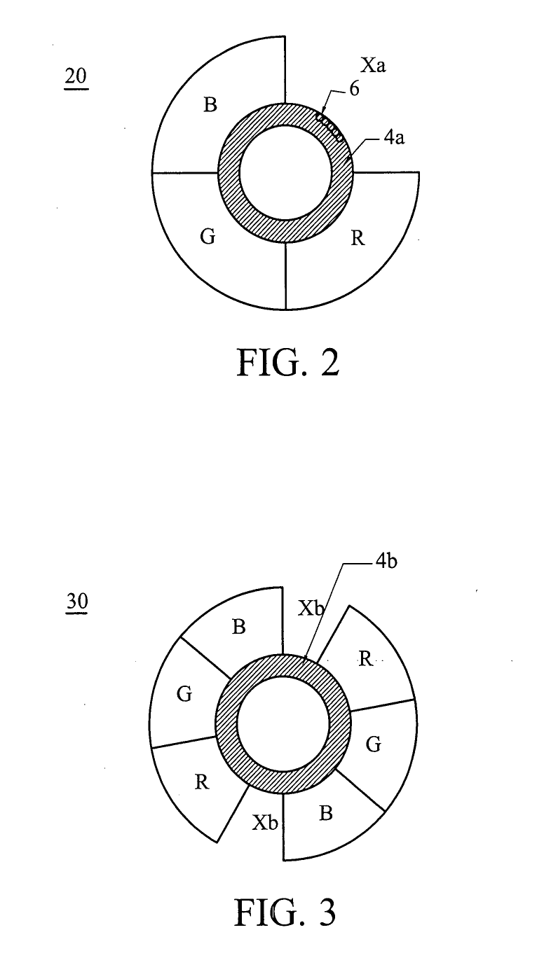

In FIG. 2, a color wheel 20 of a first embodiment of the invention includes a carrier 4a, a plurality of color filters fixedly disposed around the carrier 4a to form at least one gap Xa, and a balancer 6 disposed at the carrier 4a corresponding to the gap Xa. The carrier 4a is centrally pivoted to the shaft of the motor so that the color wheel 20 can be driven by the motor. In this embodiment, the number of the color filters is three, including red, green and blue one, labeled by symbols “R”, “G” and “B”, respectively. The color filters are fixedly disposed around the peripheral of the carrier 4a, and the gap Xa is located between the red and blue color filters “R” and “B”.

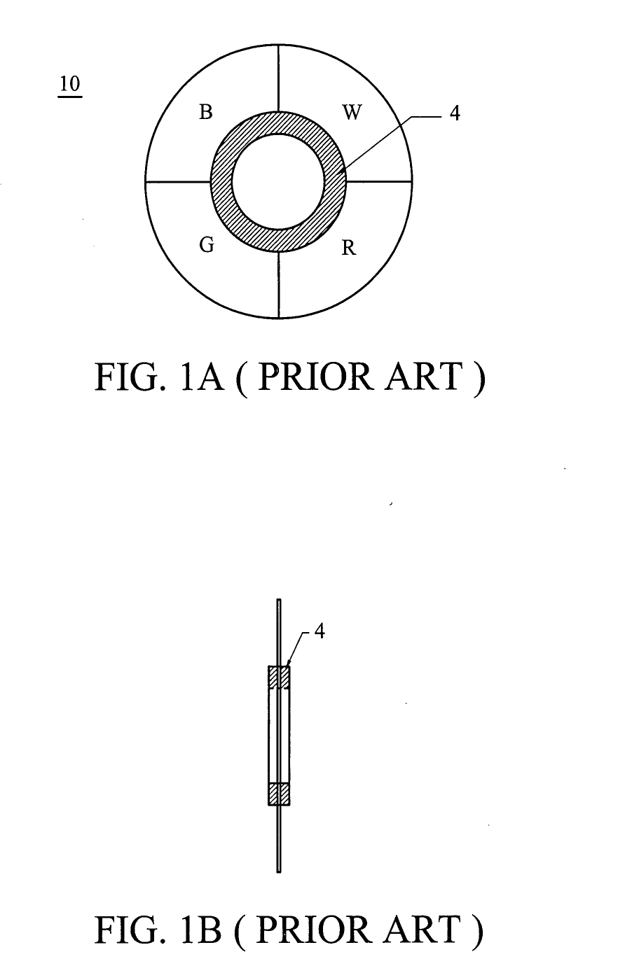

In comparison with FIG. 1A, it is understood that the color wheel 20 differs from the color wheel 10 of FIG. 1A in that the transparent filter “W” of the color wheel 10 is directly replaced by the gap Xa to reduce the loss of light transmission rate when the light beam pass through the transparent filter “W” of the color wheel 10.

The balancer 6 disposed at the carrier 4a corresponding to the gap Xa forms a moment couple with respect to the red, green and blue color filters “R”, “G” and “B”, to balance the weight thereof, to keep center of mass of the color wheel 20 maintaining at the geometric rotation center of the color wheel 20, and to avoid vibration and noise from the high-speed rotational color wheel 20. In this embodiment, the balancer 6 can be made of plastic, rubber or metal, and the shape of the balancer 6 can be sectional or circular.

In FIG. 3, a color wheel 30 of a second embodiment of the invention includes a carrier 4b and two sets of three-color filters “R”, “G” and “B” fixedly disposed around the carrier 4b at a peripheral thereof to form two corresponding gaps Xb, instead of the transparent filter “W” of the color wheel 10 of FIG. 1A. In this embodiment, the two corresponding gaps Xb have the same size. Note that the described balancer 4 or the like can be optionally eliminated if the corresponding gaps have the same size, and a moment couple can be formed therebetween to balance the rotational color wheel 30.

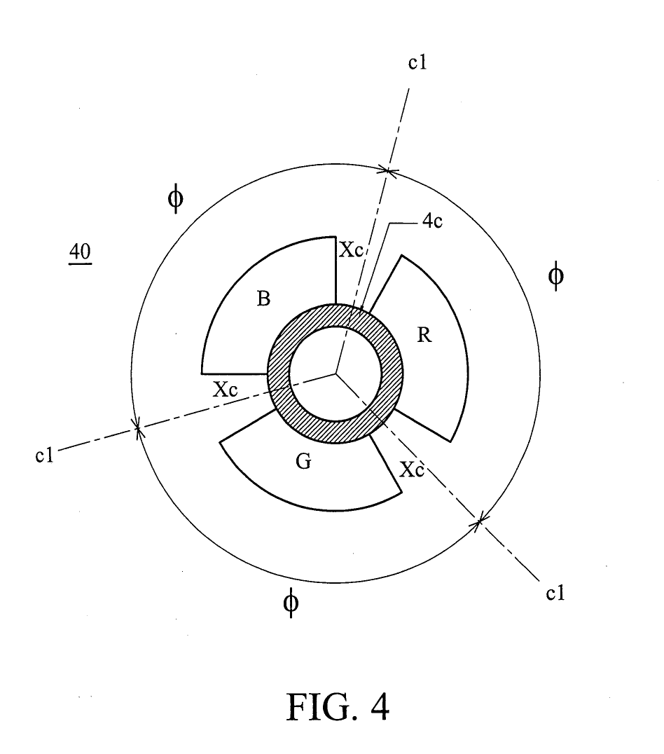

In FIG. 4, a color wheel 40 of a third embodiment of the invention includes a carrier 4c and three spaced color filters “R”, “G” and “B” fixedly disposed around the carrier 4b at a peripheral thereof to symmetrically form three gaps Xc having a central line cl, and an angle φ is formed between the central lines cl of the gaps Xc with respect to a center of the carrier 4c, instead of the transparent filter “W” of the color wheel 10 of FIG. 1A. In this embodiment, the three gaps Xc have the same size, and the angle φ formed between two adjacent central lines cl is 120 degree. Note that the number of the gap Xc is not limited to the disclosed embodiment, and the gaps Xc can be asymmetrically arranged with respect to the center of the carrier 4c as a moment couple can be formed on the color wheel 40 to balance the rotational color wheel 30, such as the use of the described balancer 6.

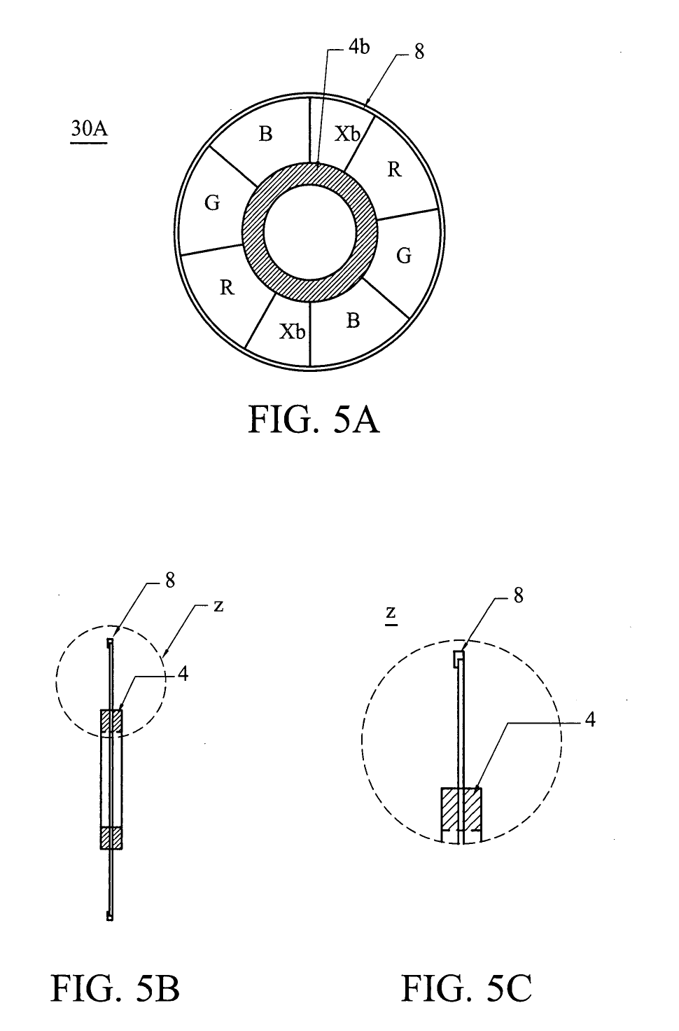

In FIGS. 5A-5C, a color wheel 30A of a fourth embodiment of the invention is presented. The color wheel 30A of FIG. 5A differs from the color wheel 30 of FIG. 3 in that the color wheel 30A further includes a fixing ring 8 disposed along edges of the color filters “R”, “G” and “B” to increase the stabilization of the rotational color wheel 30A. Furthermore, as shown in FIGS. 5B and 5C, the fixing ring 8 extends to one side of the color filters “R”, “G” and “B”. It is to be understood that the fixing ring 8 is not limited to be disposed along edges of the color filters “R”, “G” and “B” of the color wheel 30 of FIG. 3. Similarly, the fixing ring 8 is capable of being disposed on the color wheels 20 and 40 shown in FIG. 2 and 4, respectively. In this embodiment, the fixing ring 8 is made of plastic, rubber or metal.

Thus, it is to be understood that the shape of the carrier is not limited to the circular one and the connection between the carrier and the color filters is not limited to the bonding. The color filters can be fixedly disposed at the periphery of the carrier by adhesion, jacketing or equivalent bonding methods.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A color wheel for a projection system, comprising:
a carrier; and
a plurality of color filters fixedly disposed at the periphery of the carrier,
wherein there is at least one gap formed between two of the color filters.

2. The color wheel as claimed in claim 1, wherein the plurality of color filters comprises red, green and blue color filters.

3. The color wheel as claimed in claim 1, wherein the color filters are fixedly disposed at the periphery of the carrier by clamping, adhesion, jacketing or equivalent bonding methods.

4. The color wheel as claimed in claim 1, further comprising a balancer disposed at the carrier corresponding to the gap.

5. The color wheel as claimed in claim 4, wherein the balancer is made of plastic, rubber or metal.

6. The color wheel as claimed in claim 1, wherein the number of the gap is at least two, and the gaps have the same size.

7. The color wheel as claimed in claim 1, wherein the number of the gap is at least two, and the gaps are symmetrically arranged.

8. The color wheel as claimed in claim 1, wherein the number of the gap is three and the gaps are the same size.

9. The color wheel as claimed in claim 8, wherein each gap has a central line, and an angle of 120 degree is formed between two adjacent central lines of the gaps with respect to a center of the carrier.

10. The color wheel as claimed in claim 1, further comprising a fixing ring disposed along edges of the color filters.

11. The color wheel as claimed in claim 10, wherein the fixing ring is made of plastic, rubber or metal.

12. A projection system for forming an image, comprising:
a light source generating a light beam;
a color wheel performing color separation on the light beam of the light source, and comprising a carrier and a plurality of color filters fixedly disposed at the periphery of the carrier, wherein there at least one gap formed between two of the color filters; and
a digital micromirror element for reflecting the performed filtered light beam of the light source from the color wheel to form the image.

13. The projection system as claimed in claim 12, wherein the color wheel further comprises a balancer disposed at the carrier corresponding to the gap.

14. The projection system as claimed in claim 13, wherein the balancer is made of plastic, rubber or metal.

15. The projection system as claimed in claim 12, wherein the number of the gap is at least two, and the gaps have the same size.

16. The projection system as claimed in claim 15 wherein the gaps are symmetrically arranged.

17. The projection system as claimed in claim 12, wherein the number of the gap is three and the gaps are the same size.

18. The projection system as claimed in claim 17, wherein each gap has a central line, and an angle of 120 degree is formed between the adjacent two of the central lines of the gaps with respect to a center of the carrier.

19. The projection system as claimed in claim 12, further comprising a fixing ring disposed along edges of the color filters.

20. The projection system as claimed in claim 19, wherein the fixing ring is made of plastic, rubber or metal.
